(19) United States
(12) Patent Application Publication
(10) Pub. No.: US 2019/0098110 A1
(43) Pub. Date: Mar. 28, 2019

(54) CONFERENCE SYSTEM AND APPARATUS AND METHOD FOR MAPPING PARTICIPANT INFORMATION BETWEEN HETEROGENEOUS CONFERENCES

(71) Applicant: SAMSUNG SDS CO., LTD., Seoul (KR)

(72) Inventors: Hee-Tae YOON, Seoul (KR); Do-Hyung IM, Seoul (KR); Jun-Ho KANG, Seoul (KR); Seong-Joong CHANG, Seoul (KR)

(73) Assignee: SAMSUNG SDS CO., LTD., Seoul (KR)

(21) Appl. No.: 16/135,762

(22) Filed: Sep. 19, 2018

(30) Foreign Application Priority Data
Sep. 22, 2017 (KR) 10-2017-0122292

(51) Int. Cl. H04L 29/08; H04L 29/06; H04L 12/18

(52) U.S. Cl. CPC H04L 67/303; H04L 67/146; H04L 12/1813; H04L 67/22; H04L 65/1066

(57) ABSTRACT

A conference system and an apparatus and method for mapping participant information between heterogeneous conferences are provided. The apparatus for mapping participant information according to one embodiment of the present disclosure includes: a first acquirer configured to acquire identification information of a first terminal accessing a first conference server; an access history inquirer configured to inquire an access history database to extract access history information corresponding to the identification of the first terminal; a second acquirer configured to acquire one or more pieces of mapping candidate identification information from the extracted access history information; a selector configured to select a terminal corresponding to the mapping candidate identification information among one or more terminals accessing a second conference server as a second terminal; and a mapper configured to map identification information of the second terminal to the identification information of the first terminal.

### CROSS-REFERENCE TO RELATED APPLICATION(S)

This application claims the benefit under 35 USC § 119(a) of Korean Patent Application No. 10-2017-0122292, filed on Sep. 22, 2017, in the Korean Intellectual Property Office, the entire disclosure of which is incorporated herein by reference for all purposes.

### BACKGROUND

### 1. Field

The following description relates to a technology for mapping between heterogeneous conferences in a multi-participant conference system.

### 2. Description of Related Art

Recently, attempts have been made to improve convenience of conference users by interworking between different types of conferences. For example, if an audio conference and a separate web conference are set up and the web conference is associated with the audio conference, it is possible to provide various additional services, such as document sharing, screen sharing, sharing of writing, etc., through simultaneously the web conference and the audio conference.

As such, in the case of interworking between heterogeneous conferences, there is a need to manage information about a terminal of a user attending a first conference and information about a terminal of the same user attending a second conference by mapping the terminal information of different conferences to each other. However, conventionally, there is no method in which different terminals participating in different types of conferences can recognize each other as the terminals of the same user, and accordingly, there is an inconvenience in that a participant has to manually connect pieces of corresponding information.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a technical means for mapping information of terminals participating in different types of conferences to each other in a conference system.

In one general aspect, there is provided an apparatus for mapping participant information including: a first acquirer configured to acquire identification information of a first terminal accessing a first conference server; an access history inquirer configured to inquire an access history database to extract access history information corresponding to the identification of the first terminal; a second acquirer configured to acquire one or more pieces of mapping candidate identification information from the extracted access history information; a selector configured to select a terminal corresponding to the mapping candidate identification information among one or more terminals accessing a second conference server as a second terminal; and a mapper configured to map identification information of the second terminal to the identification information of the first terminal.

The access history information may include identification information of a terminal used by a particular user to access the first conference server, identification information of a terminal used by the particular user to access the second conference server, and one or more access history records including account information of the particular user.

The apparatus may further include a storage configured to, when the access history information corresponding to the identification information of the first terminal does not exist or when the terminal corresponding to the mapping candidate identification information does not exist among the one or more terminals accessing the second conference server, receive account information of a participant attending a first conference and identification information of a terminal used by the participant to access the second conference server from the first terminal, and store the received account information and identification information, which are mapped to the identification information of the first terminal, in the access history database.

When there are two or more terminals that correspond to the mapping candidate identification information, the selector may provide information about the two or more terminals to the first terminal and select a terminal for which a selection value is received from the first terminal as the second terminal.

When there are two or more terminals that correspond to the mapping candidate identification information, the selector may select a terminal having more access histories stored in the access history database than the other terminals of the two or more terminals as the second terminal.

When there are two or more terminals that correspond to the mapping candidate identification information, the selector may select a terminal having an access history most recently stored in the access history database from among the two or more terminals as the second terminal.

In another general aspect, there is provided a method performed in a computing device comprising one or more processors and a memory configured to store one or more programs executed by the one or more processors, the method including: acquiring identification information of a first terminal accessing a first conference server; extracting access history information corresponding to the identification information of the first terminal by inquiring an access history database; acquiring one or more pieces of mapping candidate identification information from the extracted access history information; selecting a terminal corresponding to the mapping candidate identification information from among one or more terminals accessing a second conference server as a second terminal; and mapping identification information of the second terminal to the identification information of the first terminal.

The access history information may include identification information of a terminal used by a particular user to access the first conference server, identification information of a terminal used by the particular user to access the second conference server, and one or more access history records including account information of the particular user.

The method may further include, when the access history information corresponding to the identification information of the first terminal does not exist or when the terminal corresponding to the mapping candidate identification information does not exist among the one or more terminals accessing the second conference server, receiving account information of a participant attending a first conference and identification information of a terminal used by the participant to access the second conference server from the first terminal and storing the received account information and identification information, which are mapped to the identification information of the first terminal, in the access history database.

The selecting of the terminal as the second terminal may include, when there are two or more terminals that correspond to the mapping candidate identification information, providing information about the two or more terminals to the first terminal and selecting a terminal for which a selection value is received from the first terminal as the second terminal.

The selecting of the terminal as the second terminal may include, when there are two or more terminals that correspond to the mapping candidate identification information, selecting a terminal having more access histories stored in the access history database than the other terminals of the two or more terminals as the second terminal.

The selecting of the terminal as the second terminal may include, when there are two or more terminals that correspond to the mapping candidate identification information, selecting a terminal having an access history most recently stored in the access history database from among the two or more terminals as the second terminal.

Other features and aspects will be apparent from the following detailed description, the drawings, and the claims.

### BRIEF DESCRIPTION OF THE DRAWINGS

FIG. 1 is a block diagram for describing a conference system according to one embodiment of the present disclosure.

FIG. 2 is a block diagram for describing a detailed configuration of an apparatus for mapping participant information according to one embodiment of the present disclosure.

FIG. 3 is a flowchart for describing a conference participant information mapping process in an apparatus for mapping participant information according to one embodiment of the present disclosure.

FIG. 4 is a block diagram for describing an example of a computing environment including a computing device suitable to be used in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

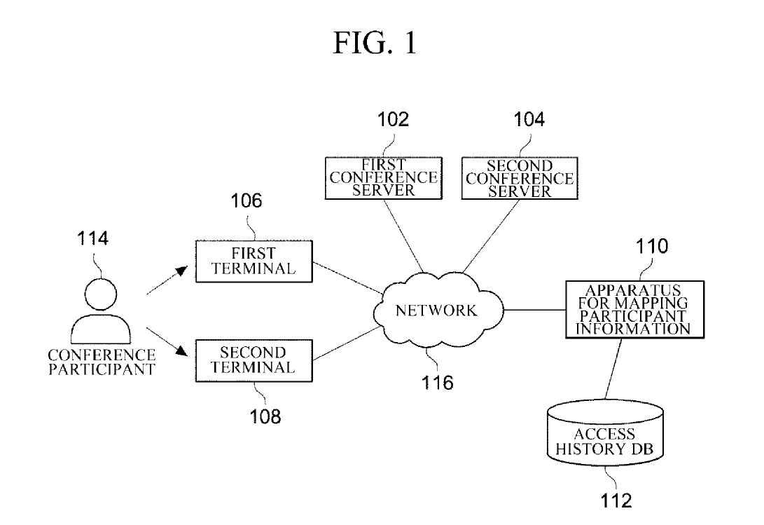

FIG. 1 is a block diagram for describing a conference system 100 according to one embodiment of the present disclosure. As illustrated, the conference system 100 according to one embodiment of the present disclosure includes a first conference server 102, a second conference server 104, a first terminal 106, a second terminal 108, an apparatus 110 for mapping participant information, and an access history database 112.

The first conference server 102 is a server for providing a first conference service. In one embodiment, the first conference server 102 may be a server for providing any one of an audio conference, a video conference, and a web conference.

The second conference server 104 is a server for providing a second conference service. Here, the second conference may be different from the first conference. For example, in a case where the first conference is an audio conference, the second conference may be a web conference providing a function, such as screen sharing, sharing of writing, and the like. However, embodiments of the present disclosure are not limited to a particular type of conference.

In one embodiment, the second conference server 104 may provide the second conference in association with the first conference set up in the first conference server 102. For example, in a case where the first conference server 102 provides an audio conference, the second conference server 104 may provide web conference services, such as screen sharing, sharing of writing, and document sharing between participants of the audio conference, in association with the audio conference.

The first terminal 106 is a terminal used by a conference participant 114 who accesses the first conference server 102. In addition, the second terminal is a terminal used by the conference participant 114 to access the second conference server 104. In the disclosed embodiments, the first terminal 106 and the second terminal 108 may include any types of communication devices such as a public switched telephone network (PSTN) phone, a voice-over-Internet-protocol (VoIP) terminal, a mobile communication terminal, a desktop computer, a notebook computer, a tablet terminal, a smartphone, etc., which can be provided with an audio conference service and a web conference service.

The first terminal 106 and the second terminal 108 may be devices equipped with a function to access the first conference server 102 and the second conference server 104, respectively. For example, in a case where the first conference server 102 is a server for providing an audio conference, the first terminal 106 may be a device having a voice communication function for accessing the audio conference. Similarly, in a case where the second conference server 104 is a server for providing a web conference, the second terminal may be a device having a packet communication function to access the web conference. In the disclosed embodiments, the first terminal 106 and the second terminal 108 may be physically distinct devices, but they may be physically same device according to other embodiments. For example, a conference participant may access an audio conference using his/her mobile device and may simultaneously access a web conference using the same device. However, even in this case, terminal identification information at the audio conference and terminal identification information at the web conference may be different from each other.

The apparatus 110 for mapping participant information is a device for mapping identification information of the first terminal 106 to identification information of the second terminal 108 when the first terminal 106 and the second terminal 108 are used by the same conference participant 114. For example, it is assumed that the conference participant 114 accesses the first conference set up in the first conference server 102 through the first terminal 106 and at the same time accesses the second conference set up in the second conference server 104 through the second terminal 108. In this case, the identification information of the first terminal 106 identified at the first conference may be different from the identification information of the second terminal 108 identified at second conference may be different. For example, the identification information of the first terminal 106 identified at the first conference may be a phone number of the first terminal 106 and the identification information of the second terminal 108 identified at the second conference may be a media access control (MAC) address.

In a case where the first conference and the second conference are provided in association with each other, even when the first terminal 106 and the second terminal 108 are all used by the conference participant 114, other participants attending the first conference and the second conference may recognize the first terminal 106 and the second terminal 108 as separate terminals. Thus, the apparatus 110 for mapping participant information may map the identification information of the first terminal 106 and the identification information of the second terminal 108, thereby allowing the other conference participants to recognize that all the two terminals are used by the conference participant 114. According to embodiments, the apparatus 110 for mapping participant information may be present as a separate device in a network, or may be implemented as one element in the first conference server 102 or the second conference server 104.

The access history database 112 is a database which is connected to the apparatus 110 for mapping participant information and stores and manages access histories of the conference participant 114 accessing the first conference and the second conference. In one embodiment, when the conference participant 114 accesses the first conference using the first terminal 106 and simultaneously accesses the second conference associated with the first conference using the second terminal 108, an access history record may be stored in the access history database 112 as shown below.

Identification information of the first terminal 106 at the first conference—account information of the conference participant 114—identification information of the second terminal 108 at the second conference

Here, the identification information at the first conference is information for identifying a terminal accessing the first conference. For example, when the first conference is a PTSN-based audio conference, the identification information at the first conference may be a phone number of the terminal accessing the first conference.

In addition, the identification information at the second conference is information for identifying a terminal accessing the second conference. For example, when the second conference is a web conference, the identification information at the second conference may be a MAC address of the terminal accessing the second conference.

The account information may include a user ID of the conference participant 114 and a display name of the conference participant 114 used at the first conference and the second conference.

Meanwhile, the first conference server 102, the second conference server 104, the first terminal 106, the second terminal 108, the apparatus 110 for mapping participant information, and the access history database 112 may transmit and receive data to and from each other over a communication network 116. In some embodiments, the communication network 116 may include the Internet, one or more local area networks (LANs), one or more wide area networks (WANs), cellular networks, mobile networks, other types of networks, or a combination thereof.

In the disclosed embodiments, the first conference server 102, the second conference server 104, the first terminal 106, the second terminal 108, the apparatus 110 for mapping participant information, and the access history database 112 may be implemented on a computing device including one or more processors and a computer-readable recording medium connected to the one or more processors. The computer-readable recording medium may be present inside or outside of the processors and may be connected to the processors by various well-known means. The processors present inside the computing device may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

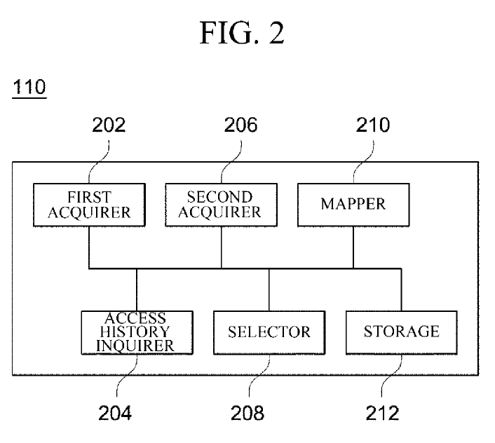

FIG. 2 is a block diagram for describing a detailed configuration of an apparatus 110 for mapping participant information according to one embodiment of the present disclosure. As illustrated, the apparatus 110 for mapping participant information according to one embodiment of the present disclosure includes a first acquirer 202, an access history inquirer 204, a second acquirer 206, a selector 208, and a mapper 210, and may further include a storage 212 when necessary.

The first acquirer 202 acquires identification information of a first terminal 106 accessing a first conference server 102.

The access history inquirer 204 inquires the access history database 112 to extract access history information (record) corresponding to the identification information of the first terminal 106. If there is a history that the conference participant 114 previously accessed the first conference server 102 using the first terminal 106, corresponding record exists in the access history database 112 and the access history inquirer 204 can extract access history information corresponding to the identification information of the first terminal 106 by inquiring the record.

The second acquirer 206 acquires one or more pieces of mapping candidate identification information from the obtained access history information. As described above, the access history information may include information about a second conference participant terminal mapped to the first terminal 106 and the second acquirer 206 may acquire identification information of the second conference participant terminal which is recorded in the access history information as the mapping candidate identification information. If there are two or more pieces of access history information corresponding to the first terminal 106, there may be two or more pieces of mapping candidate identification information. For example, when a conference participant accesses an audio conference with the same phone terminal and accesses a web conference with each of a company computer and a home computer, an access history in which the phone terminal and the company computer are mapped to each other and an access history in which the same phone terminal and the home computer are mapped to each other may exist in the access history database. In this case, the mapping candidate identification information may be both a MAC address of the company computer and a MAC address of the home computer.

The selector 208 selects a terminal corresponding to the mapping candidate identification information from one or more terminals accessing the second conference server 104 as the second terminal 108. That is, the selector 208 selects the terminal corresponding to the mapping candidate identification information from one or more terminals currently accessing the second conference server 104, that is, a terminal having a history of being previously mapped to the first terminal 106, as the second terminal 108 in use by the conference participant 114.

The mapper 210 maps identification information of the selected second terminal 108 to the identification information of the first terminal 102.

Meanwhile, it may happen that access history information corresponding to the identification information of the first terminal 106 is not found in the access history database 112 when the access history inquirer 204 inquires the access history database 112. For example, in the case where the conference participant 114 accesses the first conference using the first terminal 106 for the first time, a previous access history does not exist in the access history database 112.

In addition, it may happen that a terminal corresponding to the mapping candidate identification information does not exist among one or more terminals accessing the second conference server 104. For example, in the case where the conference participant 114 has previously accessed the second conference using another terminal and then currently accesses the second conference using the second terminal 106 for the first time, only an access history of the other terminal exists in the access history database 112 but an access history of the second terminal 106 does not exist.

As such, when the access history information corresponding to the identification information of the first terminal 106 does not exist in the access history database 112, or when a terminal corresponding to the mapping candidate identification information does not exist among one or more terminals accessing the second conference server 104, the storage 112 receives account information of the conference participant 114 and identification information of a terminal used by the conference participant 114 to access the second conference server 104 through the first terminal 106 and stores the received account information and identification information, along with the identification information of the first terminal 102, in the access history database 112.

Meanwhile, it may happen that two or more terminals that correspond to the mapping candidate identification information may exist among one or more terminals accessing the second conference server 104. For example, it is assumed that there are access histories that the conference participant 114 has accessed the second conference server 104 using each of personal terminal A and company terminal B and currently the conference participant 114 is accessing the second conference server 104 using personal terminal A. In this case, when another participant is accessing the second conference server 104 using company terminal B, personal terminal A and company terminal B are all terminals that correspond to the mapping candidate identification information.

As such, when two or more terminals corresponding to the mapping candidate identification information exist among one or more terminals accessing the second conference server 104, the selector 208 may provide information about the two or more terminals to the first terminal 106, so that the conference participant 114 can choose one of the two or more terminals, and may consider the selected terminal as the second terminal 108.

Meanwhile, according to the embodiment, when there are two or more terminals corresponding to the mapping candidate identification information, the selector 208 may select a terminal having more access histories stored in the access history database 112 (i.e., a terminal that has been more frequently used by the conference participant 114) than the other terminals as the second terminal 108, or select a terminal having an access history more recently stored in the access history database 112 (i.e., the most recently used terminal) as the second terminal 108.

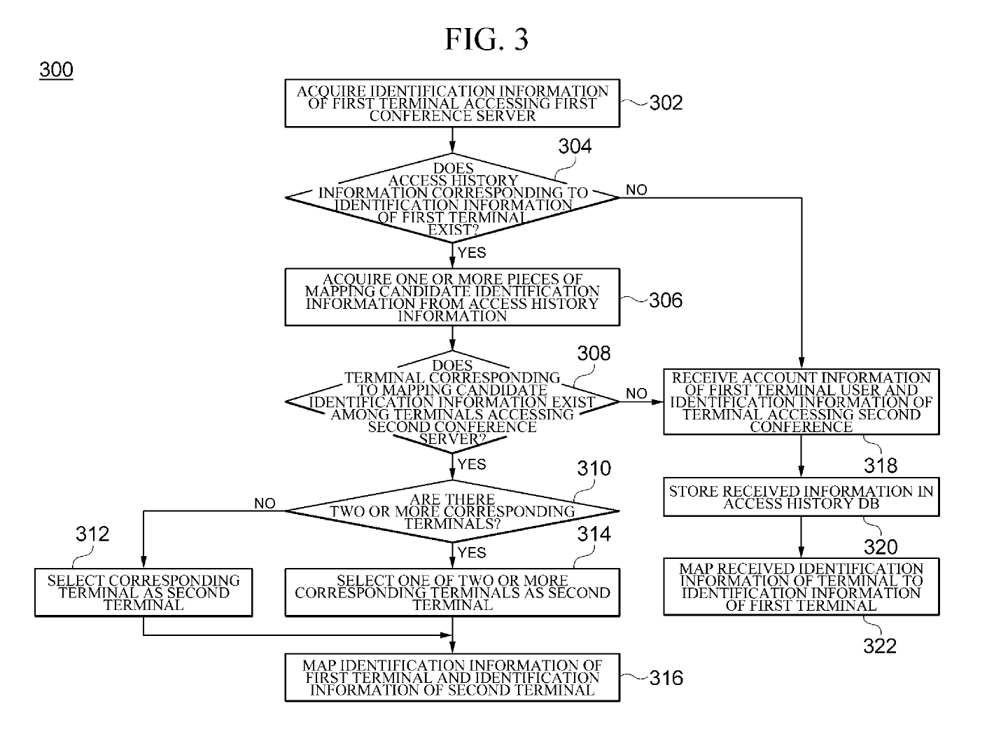

FIG. 3 is a flowchart for describing a conference participant information mapping process 300 in an apparatus 110 for mapping participant information according to one embodiment of the present disclosure. In the illustrated flowchart, the process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 302, the apparatus 110 for mapping participant information acquires identification information of a first terminal 106 accessing a first conference server 102.

In operation 304, the apparatus 110 inquires an access history database 112 and determines whether access history information corresponding to the identification information of the first terminal 106 exists.

When it is determined in operation 304 that the corresponding access history information exists, the apparatus 110 acquires one or more pieces of mapping candidate identification information from the corresponding access history information in operation 306.

In operation 308, the apparatus 110 determines whether a terminal corresponding to the mapping candidate identification information exists among one or more terminals accessing a second conference server 104.

When it is determined in operation 308 that the corresponding terminal exists, the apparatus 110 determines whether there are two or more terminals corresponding to the mapping candidate identification information in operation 310.

When it is determined in operation 310 that there is one corresponding terminal, the apparatus 100 selects the corresponding terminal as a second terminal 108 in operation 312.

Meanwhile, when it is determined in operation 310 that there are two or more terminals corresponding to the mapping candidate identification information, the apparatus 110 selects one of the two or more terminals as the second terminal 108 in operation 314. As described above, the apparatus 110 may provide information about the two or more terminals to the first terminal 106 so that the conference participant 114 can choose one of the two or more terminals, and may select the chosen terminal as the second terminal 108, select a terminal having more access histories stored in the access history database 112 (i.e., a terminal that has been more frequently used by the conference participant 114) than the other terminals as the second terminal 108, or select a terminal having an access history more recently stored in the access history database 112 (i.e., the most recently used terminal) as the second terminal 108.

In operation 316, the apparatus 110 maps identification information of the selected second terminal 108 to the identification information of the first terminal 106.

Meanwhile, when it is determined in operation 304 that the corresponding identification information does not exist or when it is determined in operation 308 that no terminal corresponding to the mapping candidate identification information exists among the one or more terminals accessing the second conference server 104, the apparatus 110 receives account information of the conference participant 114 and identification information of a terminal used by the conference participant 114 to access the second conference server 104 through the first terminal 106, in operation 318.

In operation 320, the apparatus 110 stores the account information and identification information received in operation 318, along with the identification information of the first terminal 102, in the access history database 112.

In operation 322, the apparatus 110 maps the identification of the terminal input in operation 318 to the identification information of the first terminal 102.

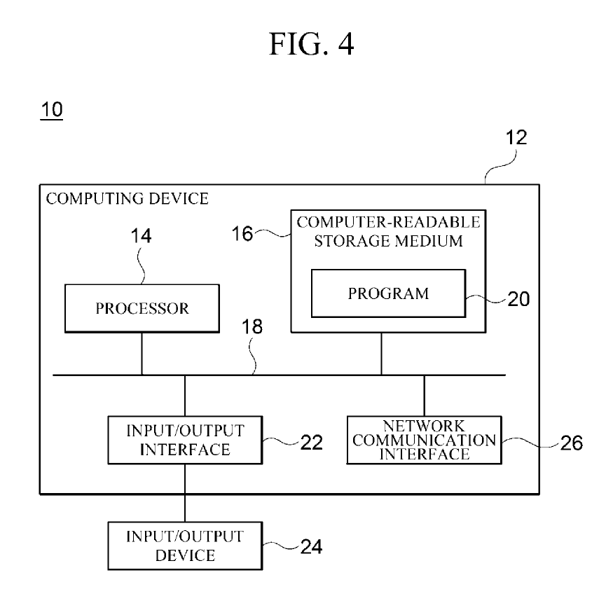

FIG. 4 is a block diagram for describing an example of a computing environment 10 including a computing device suitable to be used in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be a first conference server 102. In addition, the computing device 12 may be a second conference server 104, a first terminal 106, or a second terminal 108. The computing device 12 may include at least one processor 14, a computer-readable storage medium 16, and a communication bus 18. The processor 14 may cause the computing device 12 to operate according to the aforementioned exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the illustrative embodiment.

The computer readable storage medium 16 is configured to store computer executable commands and program codes, program data and/or information in other suitable forms. The programs stored in the computer readable storage medium 16 may include a set of commands executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the disclosed embodiments, pieces of information of terminals that are participating in different types of conferences can be mapped to each other in a conference system and thereby be regarded as a terminal of the same participant, so that it is possible to improve convenience and usability of conference participants.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for mapping participant information comprising:
a first acquirer configured to acquire identification information of a first terminal accessing a first conference server;
an access history inquirer configured to inquire an access history database to extract access history information corresponding to the identification of the first terminal;
a second acquirer configured to acquire one or more pieces of mapping candidate identification information from the extracted access history information;
a selector configured to select a terminal corresponding to the mapping candidate identification information among one or more terminals accessing a second conference server as a second terminal; and
a mapper configured to map identification information of the second terminal to the identification information of the first terminal.

2. The apparatus of claim 1, wherein the access history information includes:
identification information of a terminal used by a particular user to access the first conference server;
identification information of a terminal used by the particular user to access the second conference server; and
one or more access history records including account information of the particular user.

3. The apparatus of claim 1, further comprising a storage configured to, when the access history information corresponding to the identification information of the first terminal does not exist or when the terminal corresponding to the mapping candidate identification information does not exist among the one or more terminals accessing the second conference server, receive account information of a participant attending a first conference and identification information of a terminal used by the participant to access the second conference server from the first terminal, and store the received account information and identification information, which are mapped to the identification information of the first terminal, in the access history database.

4. The apparatus of claim 1, wherein when there are two or more terminals that correspond to the mapping candidate identification information, the selector provides information about the two or more terminals to the first terminal and selects a terminal for which a selection value is received from the first terminal as the second terminal.

5. The apparatus of claim 1, wherein when there are two or more terminals that correspond to the mapping candidate identification information, the selector selects a terminal having more access histories stored in the access history database than the other terminals of the two or more terminals as the second terminal.

6. The apparatus of claim 1, wherein when there are two or more terminals that correspond to the mapping candidate identification information, the selector selects a terminal having an access history most recently stored in the access history database from among the two or more terminals as the second terminal.

7. A method performed in a computing device comprising one or more processors and a memory configured to store one or more programs executed by the one or more processors, the method comprising:
acquiring identification information of a first terminal accessing a first conference server;
extracting access history information corresponding to the identification information of the first terminal by inquiring an access history database;
acquiring one or more pieces of mapping candidate identification information from the extracted access history information;
selecting a terminal corresponding to the mapping candidate identification information from among one or more terminals accessing a second conference server as a second terminal; and
mapping identification information of the second terminal to the identification information of the first terminal.

8. The method of claim 7, wherein the access history information includes:
identification information of a terminal used by a particular user to access the first conference server;
identification information of a terminal used by the particular user to access the second conference server; and
one or more access history records including account information of the particular user.

9. The method of claim 7, further comprising, when the access history information corresponding to the identification information of the first terminal does not exist or when the terminal corresponding to the mapping candidate identification information does not exist among the one or more terminals accessing the second conference server,
receiving account information of a participant attending a first conference and identification information of a terminal used by the participant to access the second conference server from the first terminal; and
storing the received account information and identification information, which are mapped to the identification information of the first terminal, in the access history database.

10. The method of claim 7, wherein the selecting of the terminal as the second terminal comprises, when there are two or more terminals that correspond to the mapping candidate identification information, providing information about the two or more terminals to the first terminal and selecting a terminal for which a selection value is received from the first terminal as the second terminal.

11. The method of claim 7, wherein the selecting of the terminal as the second terminal comprises, when there are two or more terminals that correspond to the mapping candidate identification information, selecting a terminal having more access histories stored in the access history database than the other terminals of the two or more terminals as the second terminal.

12. The method of claim 7, wherein the selecting of the terminal as the second terminal comprises, when there are two or more terminals that correspond to the mapping candidate identification information, selecting a terminal having an access history most recently stored in the access history database from among the two or more terminals as the second terminal.
